(19) United States
(12) Patent Application Publication
(10) Pub. No.: US 2008/0297812 A1
(43) Pub. Date: Dec. 4, 2008

(54) IMAGE PROCESSING APPARATUS AND IMAGE PROCESSING METHOD

(75) Inventor: Koichi Watanabe, Kawasaki-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/670,695

(22) Filed: Feb. 2, 2007

(51) Int. Cl. G06F 15/00

(52) U.S. Cl. 358/1.9; 358/1.13

(57) ABSTRACT

To provide a technique capable of making a contribution to control of execution of processing according to an erroneous setting content in an image processing apparatus that applies processing according to the setting content to image data.

It is configured to include: a setting information acquisition unit configured to acquire setting information that defines a content of processing applied to image data as a processing subject; an image processing unit configured to apply the processing according to the setting information acquired by the setting information acquisition unit to the image data as the processing subject; an image generation unit configured to generate an image indicating a state where the processing according to the setting information acquired by the setting information acquisition unit has been applied to the image data as the processing subject before the processing in the image processing unit is completed; a display control unit configured to display the image generated in the image generation unit; an output instruction acceptance unit configured to accept an output instruction instructing an output of processed data that is the image data to which the processing has been applied in the image processing unit; and a processed data output unit configured to output the processed data in a case where the output instruction of the processed data is accepted at the output instruction acceptance unit.

### BACKGROUND OF THE INVENTION

1. Field of the Invention

The present invention relates to an image processing apparatus that applies processing according to the setting content to image data, and more particularly, to the control of execution of processing according to the setting content.

2. Description of the Related Art

In an image processing apparatus such that performs desired image processing on image data acquired by scanning an original document, for a preview image or a thumbnail image used for image conformation or the like, there is a configuration by which preview image generation processing for image confirmation processing is performed only after the scan processing is completed (see JP-A-2004-222246).

In the related art described above, when configured to generate a preview image during the reading by the scanner, processing of the image data being read and processing of a large volume of image data, such as image data used to generate a preview image, have to be executed at the same time, and in order to avoid a problem that the performance of the apparatus is deteriorated, a preview image is generated after the scan processing is completed.

For the image processing apparatus in recent years, set items are becoming more complex with sophistication of the processing capability, and setting errors or the like are thought to readily occur. However, at the display timing of a preview image in the image processing apparatus in the related art as described above, for example, in a case where one wishes to perform copy processing, the print processing completes while he is confirming the setting content. It is therefore difficult to forestall execution of processing according to erroneous setting content in a case where complex processing settings are made.

### SUMMARY OF THE INVENTION

An object of embodiments of the invention is to provide a technique that contributes to the control of execution of processing according to an erroneous setting content for an image processing apparatus that applies processing according to the setting content on image data.

In order to solve the problems discussed above, an image processing apparatus according to one aspect of the invention includes: a setting information acquisition unit configured to acquire setting information that defines a content of processing applied to image data as a processing subject; an image processing unit configured to apply the processing according to the setting information acquired by the setting information acquisition unit to the image data as the processing subject; an image generation unit configured to generate an image indicating a state where the processing according to the setting information acquired by the setting information acquisition unit has been applied to the image data as the processing subject before the processing in the image processing unit is completed; a display control unit configured to display the image generated in the image generation unit; an output instruction acceptance unit configured to accept an output instruction instructing an output of processed data that is the image data to which the processing has been applied in the image processing unit; and a processed data output unit configured to output the processed data in a case where the output instruction of the processed data is accepted at the output instruction acceptance unit.

Also, an image processing apparatus according to another aspect of the invention includes: setting information acquisition means for acquiring setting information that defines a content of processing applied to image data as a processing subject; image processing means for applying the processing according to the setting information acquired by the setting information acquisition means to the image data as the processing subject; image generation means for generating an image indicating a state where the processing according to the setting information acquired by the setting information acquisition means has been applied to the image data as the processing subject before the processing in the image processing means is completed; display control means for displaying the image generated in the image generation means; output instruction acceptance means for accepting an output instruction instructing an output of processed data that is the image data to which the processing has been applied in the image processing means; and processed data output means for outputting the processed data in a case where the output instruction of the processed data is accepted at the output instruction acceptance means.

An image processing method according to still another aspect of the invention includes the steps of: acquiring setting information that defines a content of processing applied to image data as a processing subject; applying the processing according to the setting information acquired in the step of acquiring the setting information to the image data as the processing subject; generating an image indicating a state where the processing according to the setting information acquired in the step of acquiring the setting information has been applied to the image data as the processing subject before the processing in the step of applying the processing to the image data is completed; displaying the image generated in the step of generating the image; accepting an output instruction instructing an output of processed data that is the image data to which the processing has been applied in the step of applying the processing to the image data; and outputting the processed data in a case where the output instruction of the processed data is accepted in the step of accepting the output instruction.

### DESCRIPTION OF THE DRAWINGS

FIG. 1 is a view showing the circuit configuration of an image processing apparatus according to a first embodiment of the invention;

FIG. 2 is a view schematically showing the configuration of a scanner image processing circuit 210 of the embodiment that executes image processing of scanning or copying and generation of a reduced image, such as a thumbnail image or a preview image simultaneously;

FIG. 3 is a view showing an example of processing to concatenate-output processing results in image processing (1) and image processing (2) within one line cycle;

FIG. 4 is a functional block diagram used to describe the image processing apparatus of the embodiment;

FIG. 5 is a view used to describe an example of processing to concatenate-output image processing results in image processing (1) and image processing (2) within one page cycle;

FIG. 6 is a view used to describe an example of processing to output image processing results in image processing (1) and image processing (2) as different pages;

FIG. 7 is a view schematically showing the configuration of a scanner image processing circuit 210 according to a fourth embodiment of the invention that executes image processing of scanning or copying and generation of a reduced image, such as a thumbnail image or a preview image simultaneously;

FIG. 8 is a view used to describe an embodiment in which image processing in image processing (1) and that in image processing (2) are executed simultaneously to output the results from different interfaces;

FIG. 9 is a view showing an example of a copying operation to prevent erroneous settings by the user by executing the preview processing to display a print image outputted to an operation panel simultaneously with the reading of an original document in a fifth embodiment of the invention;

FIG. 10 is a view showing an example of a copying operation to prevent erroneous settings by the user by executing preview processing to display a print image outputted to an operation panel simultaneously with the reading of an original document in a sixth embodiment of the invention;

FIG. 11 is a view showing an example of a copying operation to prevent erroneous settings by the user by executing preview processing to display a print image outputted to an operation panel simultaneously with the reading of an original document in a seventh embodiment of the invention;

FIG. 12 is a flowchart used to describe the flow of a copying operation in an image processing apparatus according to an eighth embodiment of the invention;

FIG. 13 is a view showing an example of an operation sequence specifying timing of the reading of an original document, an operation by the user, a display on an operation portion, and a print-output;

FIG. 14 is a view showing an example of a screen display on an operation display portion 5;

FIG. 15 is a flowchart used to describe the flow of a copying operation in an image processing apparatus according to a ninth embodiment of the invention;

FIG. 16 is a view showing an example of an operation sequence specifying timing of the reading of an original document, an operation by the user, a display on an operation portion, and a print-output;

FIG. 17 is a view showing an example of the screen display on the operation display portion 5; and

FIG. 18 is a flowchart used to roughly describe the flow of processing (image processing method) in the image processing apparatus according to one embodiment of the invention.

### DESCRIPTION OF THE EMBODIMENTS

Hereinafter, embodiments of the invention will be described with reference to the drawings.

### First Embodiment

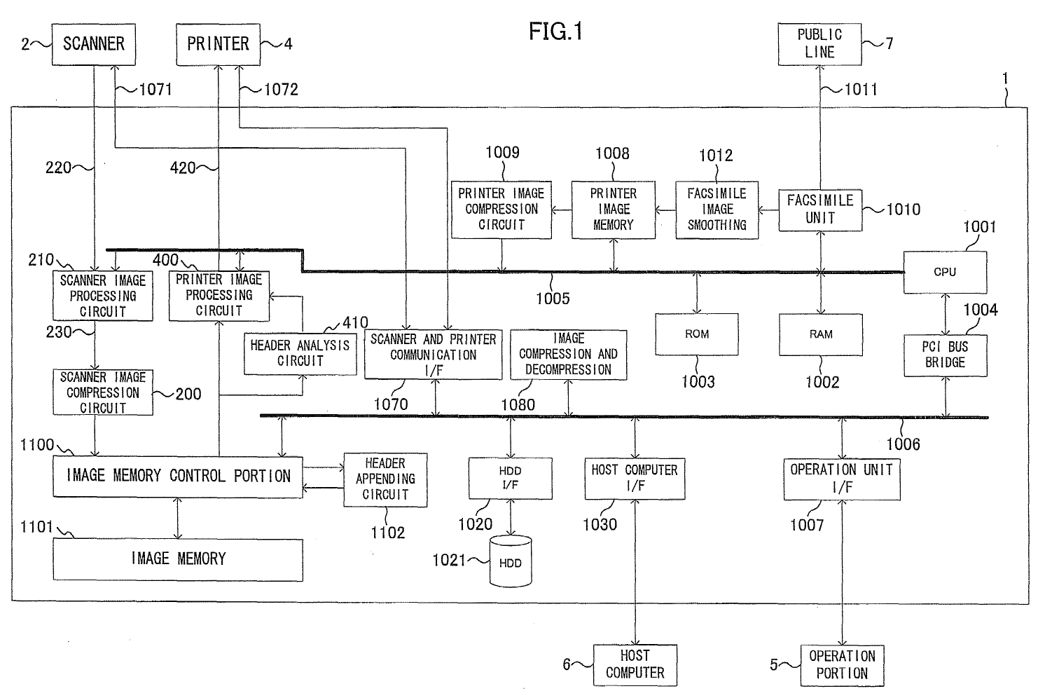

FIG. 1 is a view showing the circuit configuration of an image processing apparatus according to a first embodiment of the invention. The image processing apparatus according to this embodiment of the invention forms, for example, an MFP (MultiFunction Peripheral).

As is shown in FIG. 1, an image processing apparatus M of this embodiment is of a configuration including a system control portion 1, a scanner unit 2, a printer unit 4, and an operation display portion 5.

The system control portion 1 controls the overall system. The system control portion 1 will be described in detail below.

The scanner unit 2 includes an image input portion that scans an original document by irradiating the original document with a light source and reads an image of reflected light from the original document using a color CCD sensor, and a scanner image processing circuit 210 that performs processing, such as image reading portion γ correction, color conversion, main scanning scaling, image separation, finishing, area processing, and tone correction processing.

The printer unit 4 print-outputs an image by modulating the driving of an LD (Laser Diode) according to the image data.

The operation display portion 5 is formed of a graphical display that scans the touch panel sensor and dedicated buttons frequently used for numerical values and start and cancel operations, a state display LED, and so forth for the user to perform interactive operations by giving instructions of operation settings to the apparatus and causing the apparatus to display the setting content and the state.

The image processing apparatus M is able to make communications with a host computer 6 outside of the apparatus by a host computer I/F 1030, such as Ethernet, USB, IEEE1284, and IEEE1394 interfaces.

In addition, facsimile communications using a public line 7 are also made possible by a facsimile unit 1010.

By making communications with the scanner 2 and the printer 4, the system control portion 1 reads color or monochrome image data by controlling the operations of the scanner 2, and controls the printer 4 to perform a print-output of the color or monochrome image data on a sheet.

The read image data is stored temporarily in an image memory. Hence, by a single reading operation, it is possible to output the image repetitively as many times as required and to perform N-in-1 to place reduced images of several pages in a single sheet of paper, an image rotation that enables arbitrary collation by the unit of 90 degrees, form synthesis to put the form frame or the like on the read image, synthesis of the date, the logo, the watermark, and the like.

The read image is subjected to data compression by coding processing in the scanner image processing circuit 210 or in an image memory control portion 1100 as the need arises for the image to be accumulated on an HDD 1021 after a data volume is reduced.

Accordingly, it is possible to perform electronic sorting to enable an image output of the accumulated image an arbitrary number of times in an arbitrary order.

The system control portion 1 has the host computer I/F 1030. By enabling the LAN connection using a local connection I/F or a LAN I/F, such as IEEE1284, USB, and IEEE1394 interfaces, or the connection to the WAN or the telephone network using the modem, it executes processing, such as transmissions and receptions of a color printer that generates and print-outputs an image upon receipt of a print instruction from a linked-device (herein, the host computer 6, for example) and a color scanner and a facsimile machine that transfer an image it has read to a linked-device, as well as transmissions and receptions of images in the form of an e-mail.

By accumulating plural print jobs or images read by the scanner on the HDD 1021, it is possible to reconstruct plural documents as a single document to be print-outputted.

The capabilities of the system control portion 1 in the image processing apparatus M will now be described in detail.

A CPU 1001 is a controller that controls the overall system, and controls the image processing apparatus M to execute necessary application processing, such as the copying capability, the printer capability, the scanner capability, the facsimile capability, and the e-mail capability, the UI (User Interface) processing, communication control with a local device or a device linked to the network, and data processing, such as image data format conversion and coding, for enabling an input and an output of the image data.

A CPU local bus 1005 is a bus to connect a ROM 1003, a RAM 1002, and other peripheral devices to the CPU 1001.

The RAM 1002 is used as a program memory and a data storage region for the CPU 1001 to execute processing.

The ROM 1003 is used as a memory region for the boot program necessary for the system start-up, programs necessary for the CPU 1001 to achieve various capabilities, and fixed data. The programs and the data on the ROM 1003 can be held on the ROM 1003 in the form of compressed data and they can be executed by being developed on the RAM 1002.

A facsimile unit 1010 is a modulation and demodulation device for the connection to a public line 1011, such as the PSTN and the ISDN, and it enables facsimile transmissions and receptions, a remote connection by means of the telephone line, and the internet connection by means of the ISP connection.

A PCI bus 1006 is connected to the host bus of the CPU 1001 by a PCI bus bridge 1004, which enables data transfer among the CPU 1001, a device on the local bus, and a device on the PCI bus.

It should be noted that there is a case where the CPU host bus and the CPU local bus are the same or a case where the PCI but bridge is incorporated into the CPU 1001 depending on the type of the CPU 1001.

By adopting the PCI bus, it is possible to achieve high-speed data transfer regardless of the type of the CPU 1001, which allows for the use of an existing device in compliance with the PCI bus standards.

An image memory control portion 1100 controls an image memory 1101 having a large capacity capable of accumulating encoded data of a non-compressed image or a compressed image. It executes reading of image data from the scanner 2 to the image memory 1101 and executes a print-output of the image data from the image memory 1101 to the printer 4.

Also, the image memory control portion 1100 is capable of handling image data in various formats, and it is able to select the compression method that best suites the capability to be used for monochrome or color for binary images and for monochrome or color of the copying capability and the network printer capability for multi-value images.

A header appending circuit 1102 connected to the image memory control portion 1100 appends header information specifying the attributes of an image to the image data, which is an image converted to unit rectangular blocks, when the image data in various formats, such as the copying and the printing, is developed in the image memory, and further develops the blocks of the image data including the header in the image memory as the data of a fixed size. This makes it possible to achieve the allocation by the unit of block and rotation processing by the unit of 90 degrees with ease while a 2-D page layout is maintained.

After the page editing ends, reading of the image memory is executed successively to specify the type of the read block image by a header analysis portion 410. A printer image processing portion 400 then applies decompression processing and image processing on the compressed image according the determination result of the header analysis portion to convert the image to a common image format necessary for the printer unit, and outputs the result to the printer unit 4 by way of a printer video I/F 420.

In addition, the printer image processing portion 400 is furnished with the capability of encoding and decoding image data on the image memory 1101 by the lossless variable length coding.

The CPU 1001 is able to control the image memory control portion 1100 and access the image memory 1101 by way of the PCI bus. Likewise, the other devices on the PCI bus are able to access the image memory 1101, which enables high-speed data transfer with the HDD 1021 and an external input and output I/F.

An image compression and decompression 1080 encodes image data on the image memory 1101 or the RAM 1002 serving as the system memory so as to compress the image data, and executes decompression processing by decoding the encoded data. Examples of the coding method are JPEG, MH, MR, MMR, JBIG, JBIG2 and the like as the standard methods. However, a coding method unique to the apparatus and corresponding to a processed image is also available.

In addition to the coding and decoding capability, the image compression and decompression 1080 is furnished with a binary image-to-multi-value image converting capability, a monochrome-to-color converting capability, a resolution converting capability, and a color space converting capability, and is therefore able to convert various image formats one from another.

Image data from the scanner 2 is transferred to a scanner image processing circuit 220 by a scanner video I/F 220, and is subjected to desired image processing, such as enlargement and reduction. An output of the scanner image processing circuit 210 is transferred to a scanner image compression circuit 200 by a video I/F 230, and after the image data size is reduced by performing image compression processing suitable to the image type as the need arises, it is transferred to the image memory control portion 1100. The scanner image processing circuit 210 is configured to be able to execute more than one kind of image processing at a time.

In a case where an image does not need compression processing, the scanner image compression circuit 200 allows the image data to pass without performing any processing.

A scanner and printer communication I/F 1070 transmits control information, such as a command and a status, to the scanner 2 and to the printer 4 by serial communications 1071 and 1072, respectively. The scanner 2 and the printer 4 are thus able to acquire the start-up and the state of the image processing apparatus M, the size and the type of an original document that has been read, the specification of a paper size, available quantities of sheets of paper and consumable articles, and so forth.

An HDD I/F 1020 controls the HDD 1021 having IDE or SCSI as the I/F to execute high-speed data transfer with the RAM 1002 on the CPU local bus and the image memory RAM 1101 on the PCI bus by way of the PCI bus.

The host computer I/F 1030 establishes a connection with a PC (Personal Computer) or the like using the local connection I/F, such as USB, IEEE1284, and IEEE1394 interfaces, or the network I/F, such as the Ethernet interface.

By using the LAN (Local Area Network), such as the Ethernet, for the host computer I/F 1030, it is possible to connect plural MFP's, server PC's, and client PC's flexibly, which makes it possible to construct a high-performance system in which the respective capabilities are associated with one another.

For example, a case where image data read by the MFP is transferred to a server PC linked to the LAN, and the server PC performs OCR (Optical Character Recognition) on the image thus sent to consolidate the image into image data for keeping a file in the storage inside the server PC.

By accumulating images read by the image processing apparatus M on the HDD 1021 inside the image processing apparatus M and allowing the image processing apparatus M itself to function as a file server or a WEB server, it is possible to enable a client PC linked to the LAN to directly access information in the main body of the image processing apparatus M, so that a search can be conducted through the accumulated images or the searched image can be downloaded to the client PC.

An operation portion I/F 1007 enables the control of an operation display portion (corresponding to an operation input unit and a display unit) 5 by means of the CPU 1001 by way of the PCI bus, and it is an operation display portion formed of a graphical display on which is mounted a touch panel sensor, dedicated buttons frequently used for numeral values and start and cancel operations, a state display LED, and so forth for the user to perform interactive operations by giving instructions of operation settings to the apparatus and causing the apparatus to display the setting content and the state using the operation display portion 5.

The graphical display of the operation display portion 5 is able to display image data as soon as it is read, and is also able to perform an image reading job while whether an image being read is read in desired region and size at a desired image quality is confirmed step by step in a reliable manner.

The graphical display is also used when a selection is made among the accumulated image data, and enables a selection in the form of a rough image at a high reducing ratio or a confirmation of the image content through a detail display.

In the image processing apparatus M of this embodiment that executes processing as the image scanner that reads paper information and converts it to an electronic file and processing to make a copy on a sheet of paper and keep a file of the image simultaneously, an image processing technique for enabling generation of a reduced image, such as a thumbnail image and a preview image, necessary when selecting an image or confirming the content at a high speed using a small-scaled circuit simultaneously with the image processing of normal scanning or copying will now be described.

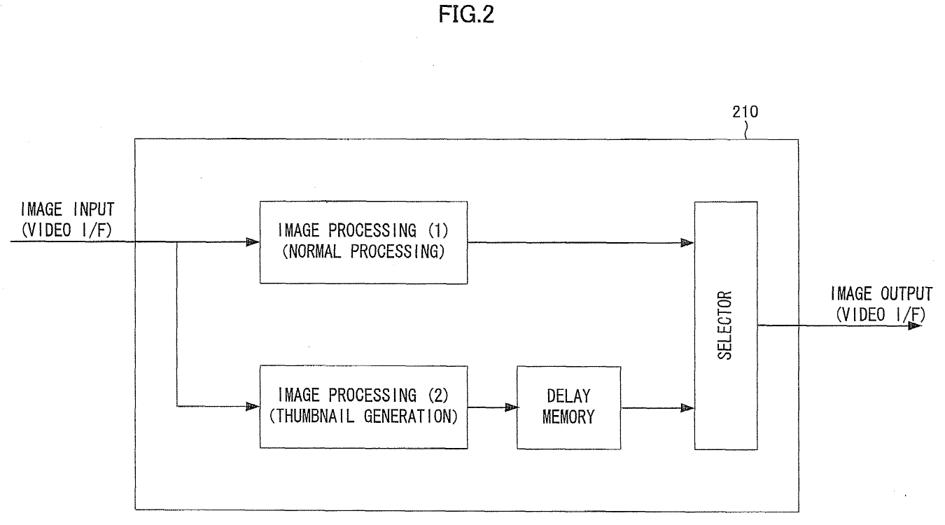

FIG. 2 is a view schematically showing the configuration of the scanner image processing circuit 210 of this embodiment that executes generation of a reduced image, such as a thumbnail image and a preview image, simultaneously with the image processing of scanning or copying.

The scanner image processing circuit (corresponding to an image processing unit and an image generation unit) 210 inputs an image input from the scanner 2 to image processing (1) to execute normal image processing of scanning or copying (processing according to setting information) and image processing (2) to execute reduced image processing at a high scaling factor for thumbnail generation (or preview image generation) at the same time for each processing to be executed simultaneously.

Because the image processing (2) to execute reduced image processing at a high scaling factor for thumbnail generation has a high scaling factor, strict computation accuracy is not necessary, and it can be used sufficiently at accuracy as rough as an integral submultiple of the original image and at the fixed or several steps of scaling kind.

Hence, the image processing (2) can be achieved by a quite simple and small-scaled circuit for simple skipping processing, averaging processing for every power of two of adjacent continuous pixels, and enables high-speed thumbnail generation processing by processing an image input in real time.

In addition, because a reduced image has a small volume of data per line and is readily accumulated in the image processing circuit, the reducing processing in the sub-scanning direction with the continuing input line can be readily achieved.

For the processing result of the image processing (2), the timing is adjusted by a delay memory and is outputted by a selector to an image output in time division with the processing result (processed data) of the image processing (1) as the normal image processing.

The output timing of the image processing results of the image processing (1) and the image processing (2) described above will now be described in detail.

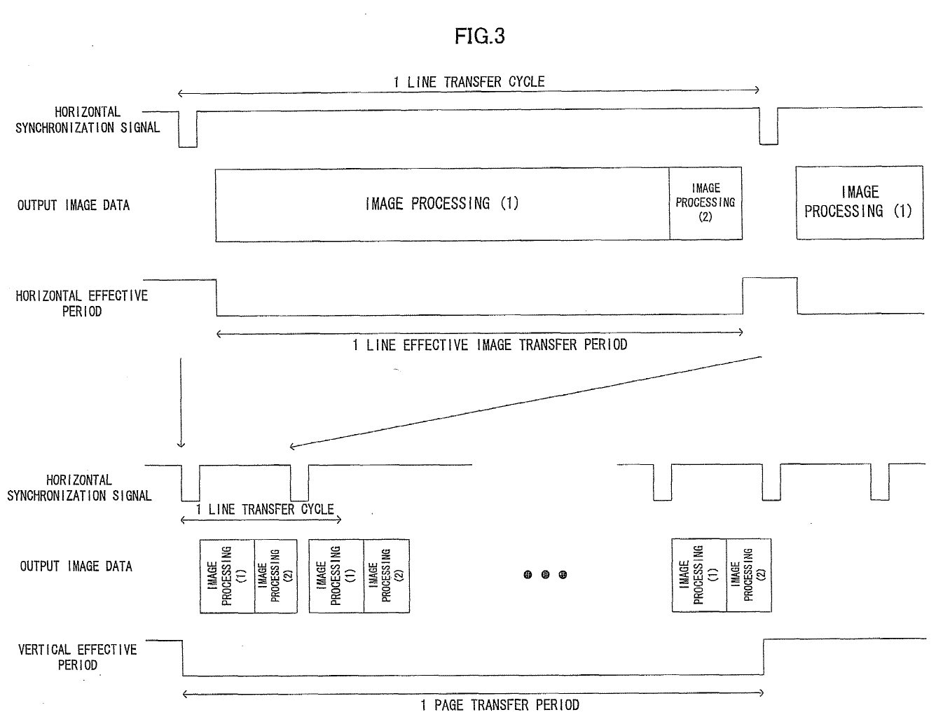

FIG. 3 is a view showing an example of processing to execute concatenation output of the processing results in the image processing (1) and the image processing (2) within one line cycle.

Initially, video transfer as an image transfer method adopted by the scanner image processing circuit 210 will be described.

As is shown in FIG. 3, the scanner image processing circuit 210 executes a video I/F transfer to transfer image data that is worth the number of lines in one page by serially transferring the image data by the unit of line in sync with a transfer clock (not shown).

A horizontal synchronization signal is a signal specifying the start of one line transfer, and one line transfer starts when it changes to a high level from a low level.

A vertical effective period signal is a signal indicating that image data is valid over the entire one page, and the image data is valid when this signal is low.

A line's worth of image data is transferred within one line transfer cycle in sync with the transfer clock.

The horizontal effective period signal is a signal indicating that the image data appearing in an output image data signal is valid, and the reception end receives the image data signal as the valid data when the vertical effective period signal is low and the horizontal effective period signal is low.

The concatenation output of the image processing results in the image processing (1) and the image processing (2) within one line cycle will now be described.

Initially, the processing result of the image processing (1) as normal processing is selected and outputted by the selector.

After a line's worth of the processing result of the image processing (1) is outputted, a line's worth of the processing result of the image processing (2) is selected and outputted by the selector.

Until one line portion of the processing result of the image processing (1) is outputted, the output result of the image processing (2) is held in the delay memory.

By concatenating two image processing results processed simultaneously and transferring them as an image of one line using an idle time in one line transfer cycle in this manner, it is possible to transfer the two image processing results simultaneously in time division by directly using the video I/F in the related art.

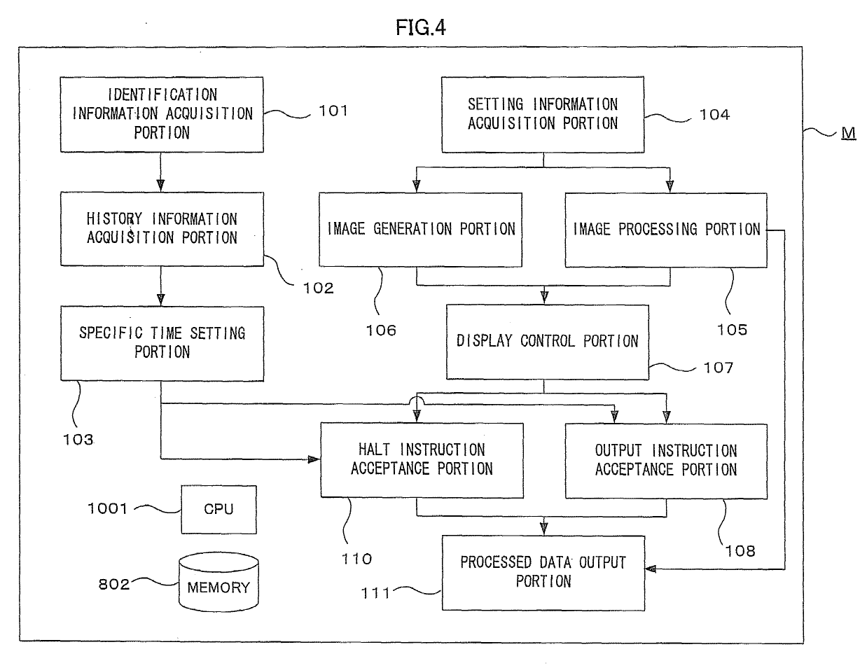

FIG. 4 is a functional block diagram used to describe the image processing apparatus of this embodiment. The image processing apparatus M of this embodiment is of a configuration including an identification information acquisition portion 101, a history information acquisition portion 102, a specific time setting portion 103, a setting information acquisition portion 104, an image processing portion 105, an image generation portion 106, a display control portion 107, an output instruction acceptance portion 108, the operation display portion 5, a halt instruction acceptance portion 110, a processed data output portion 111, the CPU 1001, and a memory 802.

The identification information acquisition portion 101 acquires identification information to identify a user who applies processing to image data as the processing subject.

The history information acquisition portion 102 acquires information about the operation history in the past by the user corresponding to the identification information according to the identification information acquired by the identification information acquisition portion 101.

The specific time setting portion 103 sets a specific time according the information acquired by the history information acquisition portion 102. By setting a time for confirmation in such a manner that a time is set shorter for the setting content at high use (familiar) and a time is set longer for the setting content at low use (seldom used) according to the operation history in the past by each user in this manner, it is possible to make a contribution to the improvement in the operation rate of the apparatus. It is thus possible to avoid a useless setting to set a long display time for a preview image or a thumbnail image for the user who is familiar with the apparatus.

The setting information acquisition portion 104 acquires setting information (print setting, copy setting, and so forth) that defines the content of processing applied to image data as the processing subject. The identification information acquisition portion 101 acquires, for example, ID information acquired through a direct operation on the image processing apparatus M or at the time of log-in processing by way of the network. The history information acquisition portion 102 and the setting information acquisition portion 104 acquire, as the need arises, the setting information stored in the memory region of the HDD 1021 in the image processing apparatus M or the like, and information stored in the host computer 6 or an unillustrated external device, such as a database, connected to the image processing apparatus M in a manner so as to enable communications.

The image processing portion 105 applies the processing according to the setting information acquired by the setting information acquisition portion 104 to the image data as the processing subject.

The image generation portion 106 generates an image showing the state where processing according to the setting information acquired by the setting information acquisition portion 104 has been applied to the image data as the processing subject before the processing in the image processing portion 105 is completed.

The display control portion 107 displays an image generated by the image processing portion 106.

The output instruction acceptance portion 108 accepts an output instruction instructing an output of processed data that is the image data to which the processing in the image processing portion 105 has been applied.

The output instruction acceptance portion 108 determines that an output instruction instructing an output of the processed data is accepted when a specific time has elapsed since the image display by the display control portion 107 was started. The specific time referred to herein means a time sufficiently long for the user to confirm visually the setting content of the desired processing, and is set to, for example, five sec. Accordingly, an output of the processed data starts when the specific time has elapsed without an output start instruction from the user, and for example, even in a case where the user forgets to give an output instruction of image data to the apparatus, the apparatus is able to execute a data output without idly waiting for the instruction.

The specific time is set according to the content of the processing defined by the setting information acquired by the setting information acquisition portion. To be more concrete, the “specific time” is set longer, for example, as the content of the processing defined by the setting information acquired by the setting information acquisition portion becomes more complex. By changing the time to confirm a preview image or a thumbnail image according to the complexity of the setting content in this manner, the user is allowed to confirm an outcome of the processing result at an easy pace in a case where, for example, complex image settings are made. It goes without saying that a time length of the specific time referred to herein can be changed as the need arises.

The output instruction acceptance portion 108 determines that an output instruction instructing an output of processed data is accepted in a case where an output instruction of processed data (for example, those according to an input in the operation display portion 5 and an instruction from an external device allowed to make communications with the image processing apparatus M) is accepted at the operation display portion 5 (for example, those according to an input in the operation display portion 5 and an instruction from an external device allowed to make communications with the image processing apparatus M).

The halt instruction acceptance portion 110 accepts a halt instruction to halt an output of processed data (for example, those according to an input in the operation display portion 5 and an instruction from an external device allowed to make communications with the image processing apparatus M).

The processed data output portion 111 outputs the processed data in a case where the output instruction of processed data is accepted at the output instruction acceptance portion 108.

The “output of processed data” referred to herein corresponds to at least any one of “saving processing into a specific memory region”, “facsimile transmission processing”, “print processing”, and “e-mail transmission processing”.

According to the configuration as above, for image data as the processing subject, execution of the desired processing on the image data and generation of a preview image or a thumbnail image to confirm the processing result are performed simultaneously, so that the generated preview image or thumbnail image can be displayed until the desired processing on the image data is completed. Because a processing load is relatively small for the generation of a preview image or a thumbnail image in general, it is easy to generate a preview image or a thumbnail image before the desired image processing applied to the image data is completed. This enables the user to schematically understand the content of the image data scheduled to be outputted before the generation of the image data to be outputted is completed. Also, by configuring as described above to display a preview image or a thumbnail image while at the same time inhibiting the processed data from being outputted unless there is an output instruction of some kind, it is possible to avoid an event that image data whose processing content is undesirable is outputted uselessly.

The processed data output portion 111 halts an output of processed data in a case where a halt instruction is accepted at the halt instruction acceptance portion 110 since the image display by the display control portion 107 is started until the specific time elapses.

By configuring in such a manner that an output is halted in a case where an output halt instruction from the user is accepted within a specific time since the display of a preview image or a thumbnail image is started in this manner, it is possible to halt an output of the image data having the content of the preview image or the thumbnail image even when the user determines that the setting content is undesirable only after he reviewed the preview image of the thumbnail image, which in turn makes it possible to avoid a useless data output.

The CPU 1001 has a role of executing various kinds of processing in the image processing apparatus M, and also has a role of achieving various capabilities by running the programs stored in the memory 802. The memory 802 is formed of, for example, the RAM 1002, the ROM 1003, the HDD 1021, or the like, and has a role of storing various kinds of information and programs used in the image processing apparatus M.

### Second Embodiment

A second embodiment of the invention will now be described. This embodiment is a modification of the first embodiment described above, and the basic apparatus configuration is the same as that of the first embodiment.

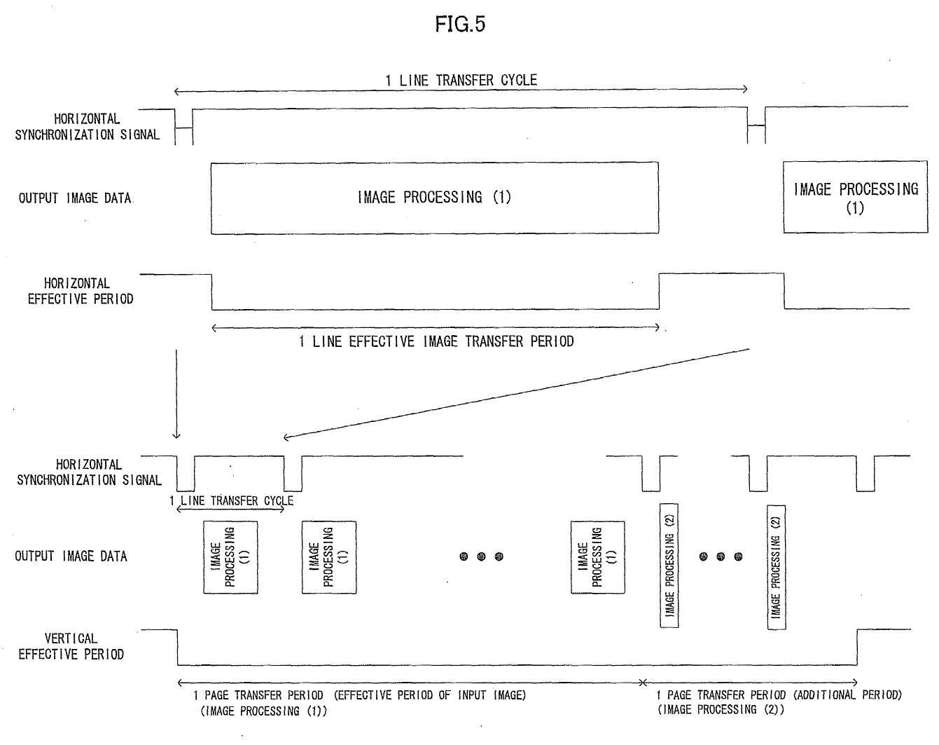

FIG. 5 is a view used to describe an example of processing to concatenate-output the image processing results in the image processing (1) and the image processing (2) within one page cycle. Assume that the video transfer as the image transferring method adopted by the scanner image processing circuit 210 is the same as the operation shown in FIG. 3.

Hereinafter, processing to concatenate-output the image processing results in the image processing (1) and the image processing (2) within one page cycle will be described.

Initially, the processing result of the image processing (1) as normal processing is selected and outputted by the selector during the vertical effective period of an input image. A page's worth of the processing result of the image processing (1) is outputted during an effective period of the input image.

After a page's worth of the processing result of the image processing (1) is outputted, a page's worth of the processing result of the second processing (2) is selected and outputted by the selector.

The output result of the image processing (2) is held in the delay memory until a page's worth of the processing result of the image processing (1) is outputted.

The vertical effective period signal being outputted is generated by the selector to be a period as long as the effective period of the input image added with the page output period of the image processing (2).

By concatenate two image processing results processed simultaneously by the unit of page and transferring them as an image of one page by adding a transfer period for one page in this manner, it is possible to transfer two image processing results by directly using the video I/F in the related art.

### Third Embodiment

A third embodiment of the invention will now be described. This embodiment is a modification of the first embodiment described above, and the basic apparatus configuration is the same as that of the first embodiment.

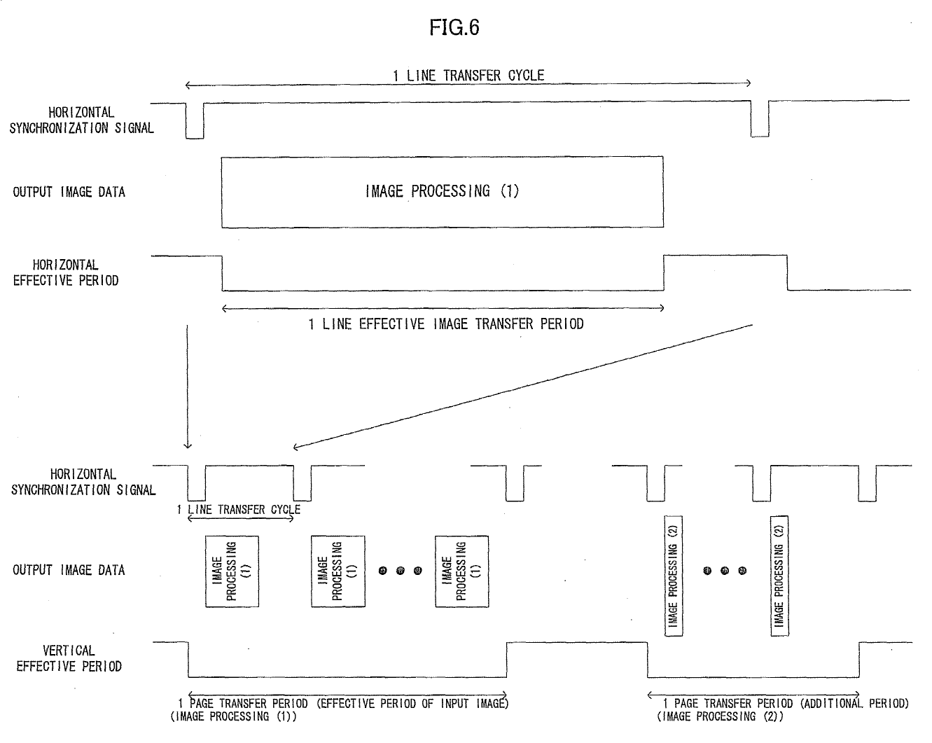

FIG. 6 is a view used to describe an example of processing to output the image processing results in the image processing (1) and the image processing (2) as different pages. Assume that the video transfer as the image transferring method adopted by the scanner image processing circuit is the same as the operation shown in FIG. 3.

Hereinafter, a method for outputting the image processing results in the image processing (1) and the image processing (2) as different pages will be described.

Initially, the processing result of the image processing (1) as normal processing is selected and outputted by the selector during the vertical effective period of an input image. A page's worth of the processing result of the image processing (1) is outputted during the effective period of the input image.

The vertical effective period for a page's worth of the input image is completed, and the state is returned to an inactive high level.

Subsequently, a page's worth of the processing result of the image processing (2) is selected and outputted by the selector. The vertical effective period signal outputted in this instance is generated newly by the selector in order to output a page's worth of the processing result of the image processing (2).

The output result of the image processing (2) is held in the delay memory until a page's worth of the processing result of the image processing (1) is outputted.

By dividing two image processing results processed simultaneously by the unit of page and transferring them as different pages by adding one page transfer period of the image processing (2) in this manner, it is possible to transfer two image processing results by directly using the video I/F in the related art.

### Fourth Embodiment

A fourth embodiment of the invention will now be described. This embodiment is a modification of the first embodiment described above, and the basic apparatus configuration is the same as that of the first embodiment.

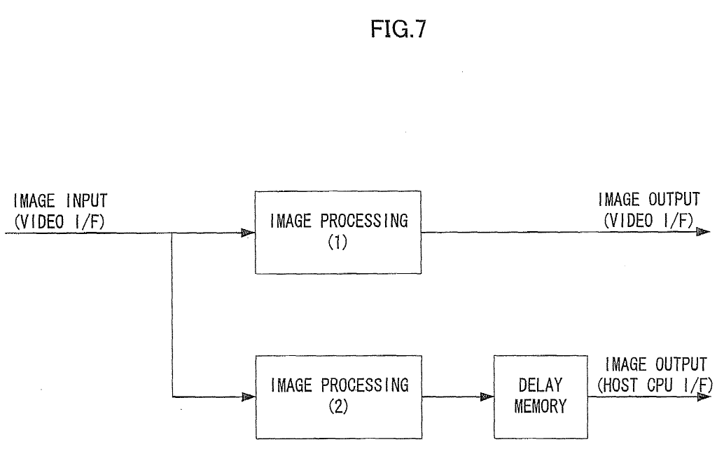

FIG. 7 is a view schematically showing the configuration of a scanner image processing circuit 210 (different from the one in FIG. 2) according to the fourth embodiment of the invention that executes generation of a reduced image, such as a thumbnail image and a preview image, simultaneously with the image processing of scanning or copying.

The scanner image processing circuit 210 inputs an image input from the scanner 2 to image processing (1) to execute normal image processing of scanning or copying and image processing (2) to execute reduced image processing at a high scaling factor for thumbnail generation at the same time for each processing to be executed simultaneously.

Because the image processing (2) to execute the reduced image processing at a high scaling factor for thumbnail generation performs a reduction at a high scaling factor, strict computation accuracy is not necessary, and it can be used sufficiently at accuracy as rough as an integral submultiple of the original image and at the fixed or several steps of scaling kind.

Hence, the image processing (1) can be achieved by a quite simple and small-scaled circuit for simple skipping processing, averaging processing for every power of two of adjacent continuous pixels, and enables high-speed thumbnail generation processing by processing an image input in real time.

In addition, because a reduced image has a small volume of data per line and is readily accumulated in the image processing circuit, the reducing processing in the sub-scanning direction with the continuing input line can be readily achieved.

Because the processing result in the image processing (2) is generated simultaneously with an image input (in real time), it is stored temporarily in the delay memory.

The host CPU 1001 is able to read the delay memory inside the scanner image processing circuit 210 via the host I/F 1005 (the connection to the host I/F is not shown).

When the host CPU is able to read the delay memory simultaneously with the image processing (2) and the reading speed is as high as the processing speed of the image processing (2), it is sufficient for the delay memory to have a capacity large enough to relax the timing.

In a case where the reading speed of the host CPU is slow or the user wishes to use a page's worth of processing result in a compete state, a delay memory having a capacity having a page's worth or several pages' worth of the processing result of the image processing (2) is necessary to meet the need.

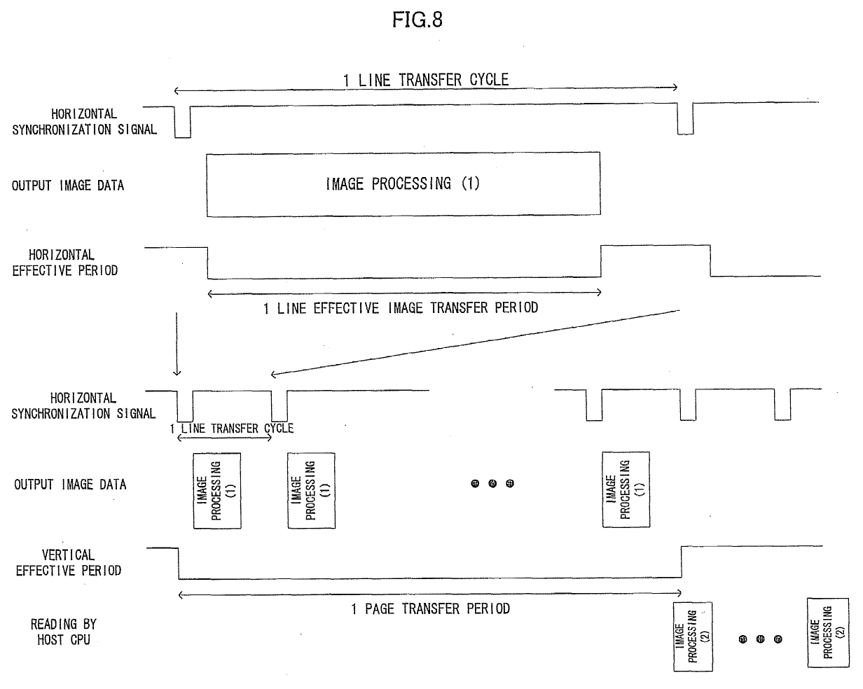

FIG. 8 is a view used to describe the embodiment in which the image processing of the image processing (1) and that of the image processing (2) are executed simultaneously and the results are outputted from different interfaces. Assume that the video transfer as the image transferring method adopted by the scanner image processing circuit is the same as the operation shown in FIG. 3.

Hereinafter, a method of executing the image processing results of the image processing (1) and the image processing (2) simultaneously and outputting the respective processing results from different interfaces will be described.

Initially, the processing result of the image processing (1) as normal processing is outputted to the video I/F during the vertical effective period of an input image. A page's worth of the processing result of the image processing (1) is outputted during the effective period of the input image.

The processing of the image processing (2) proceeds at the same time, and the processing result is accumulated in the delay memory.

The vertical effective period for a page's worth of the input image is completed, and the state is returned to an inactive high level.

Subsequently, the host CPU 1001 reads out a page's worth of the processing result of the image processing (2) accumulated in the delay memory by way of the host I/F 1005.

In this embodiment, the host CPU 1001 reads the delay memory. However, another device itself serving as a transfer master may read the delay memory to use the processing result.

For example, a configuration to enable an operation that the graphical display controller directly reads out a reduced image on the delay memory and displays the reduced image on the display is also possible.

In addition, reading of the delay memory may be started without waiting for a page's worth of the processing result to be accumulated. By configuring in this manner, it is possible to take out a reduced image at timing closer to the reading operation of the scanner.

By reading out two image processing results processed simultaneously from different I/F's by accumulating the processing result of the image processing (2) in the delay memory to be read out from the host I/F in this manner, it is possible to transfer two image processing results by directly using the video I/F in the related art.

### Fifth Embodiment

A fifth embodiment of the invention will now be described. This embodiment is a modification of the first embodiment described above, and the basic apparatus configuration is the same as that of the first embodiment.

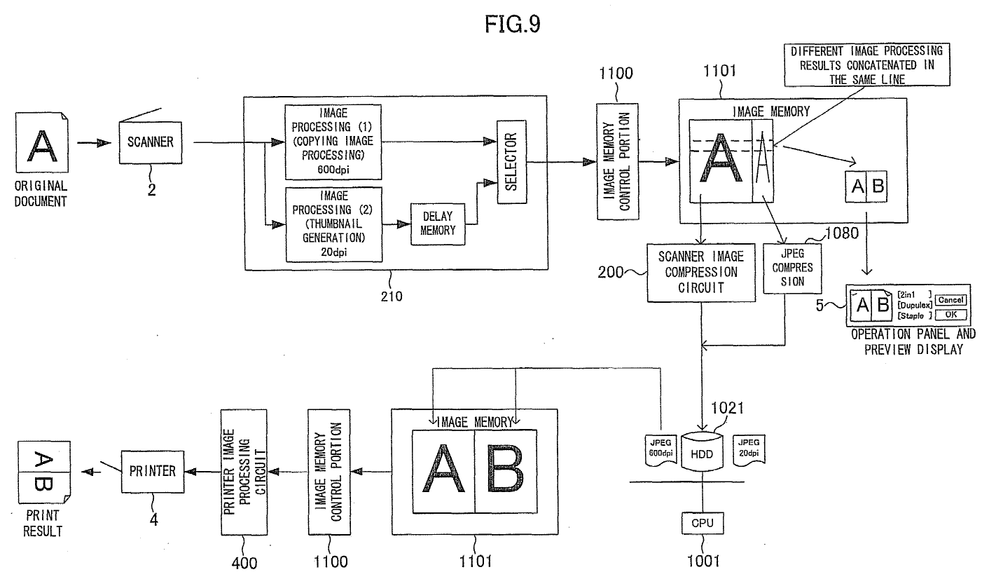

FIG. 9 is a view showing an example of a copying operation to prevent erroneous settings by the user by executing preview processing to display a print image to be outputted to the operation panel as soon as an original image is read in the “2-in-1 copy” in which two original documents are reduced and allocated to the same page.

This embodiment executes image processing to generate an image at 600 dpi used for the copying in the image processing (1).

In the image processing (2), image reducing processing to generate an image at a resolution as low as 20 dpi in generating a preview image on the operation panel is executed.

The image processing (1) and the image processing (2) are executed simultaneously, and as with the first embodiment, the image processing result of each is concatenated in the same single line and outputted by the selector.

The concatenated image data is received at the image memory control portion 1100 and transferred to the image memory 1101 two dimensionally.

An image at 600 dpi as the image data for copying is cut out at the time of reading of the image memory, converted to the JPEG coding in the scanner image compression circuit 200, and accumulated on the HDD 1021.

An image at 20 dpi as the original of a preview image of the read image becomes an image reduced in both main scanning and sub-scanning by skipping lines (one out of every 30 lines) at the time of reading of the image memory.

With the reduced images being read out, as the need arises, plural images are concatenated as preview images on the image memory to generate preview images that can be displayed on the operation panel.

The preview images generated on the image memory are transferred to the operation display portion 5 and displayed thereon.

The preview images are not necessarily generated on the image memory, and they may be directly transferred as display data of the operation panel.

By executing transferring to the operation display portion 5 each time a page's worth of reduced images are generated, it is possible to perform a preview at timing closer to the reading timing.

Because the user is able to confirm the preview images made of image data of the original documents that have been actually read before the printing, it is possible to change the settings or cancel the printing operation when the settings are inappropriate.

According to this embodiment, because the reading of original documents and the generation of preview images can be executed simultaneously, it is possible to confirm an output image at an early stage without actually making printing on a sheet of paper, which can in turn suppress the occurrence of erroneous settings.

The reduced images in the respective pages are subjected to JPEG compression processing 1080 as the need arises and accumulated on the HDD 1021. By configuring in such a manner that the copy data accumulated on the HDD 1021 will not be erased after the copying, it is possible to use the reduced images as the thumbnail image data when making a selection among the accumulated images for the printing to be executed again.

The image data at 600 dpi for copying accumulated on the HDD 1021 is read out from the HDD 1021 according to the copying settings, and print-outputted by the printer 4 after the layout is arranged neatly on the page memory.

### Sixth Embodiment

A sixth embodiment of the invention will now be described. This embodiment is a modification of the first embodiment described above, and the basic apparatus configuration is the same as that of the first embodiment.

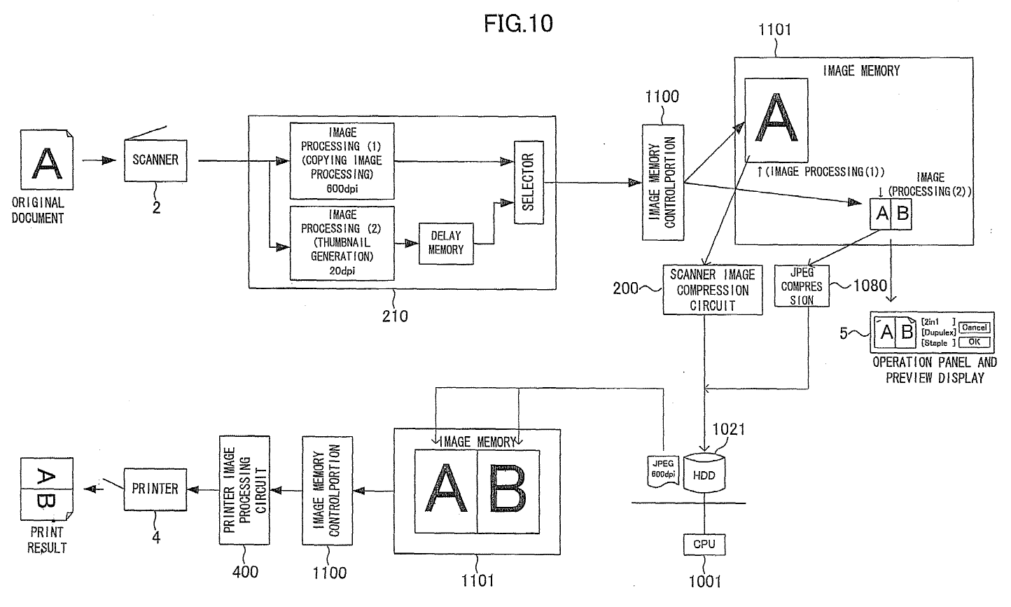

FIG. 10 is a view showing an example of a copying operation to prevent erroneous settings by the user by executing preview processing to display a print image to be outputted to the operation panel as soon as an original image is read in the “2-in-1 copy” in which two original documents are reduced and allocated to the same page.

Different from the fifth embodiment described above, in this embodiment, the image memory control portion 1100 is configured to detect the boundary between the image processing (1) and the image processing (2) depending on the number of items of the image data in one line for the image data concatenated in one line and to execute 2-D transfer to different regions in the image memory 1101.

For the image data concatenated by the unit of page within one page, it detects the boundary between the image processing (1) and the image processing (2) depending on the number of lines in the image data forming one page, and executes 2-D transfer to different regions in the image memory 1101.

For the image data transferred after it is divided into two pages, it detects the boundary between the image processing (1) and the image processing (2) according to the break of the respective transfer pages and executes 2-D transfer of the image data of the respective pages to different regions in the image memory 1101.

As with the fifth embodiment described above, because the reading of original documents and the generation of preview images can be executed simultaneously, it is possible to confirm an output image at an early stage without actually making printing on a sheet of paper, which can in turn suppress the generation of an erroneous copy.

### Seventh Embodiment

A seventh embodiment of the invention will now be described. This embodiment is a modification of the first embodiment described above, and the basic apparatus configuration is the same as that of the first embodiment.

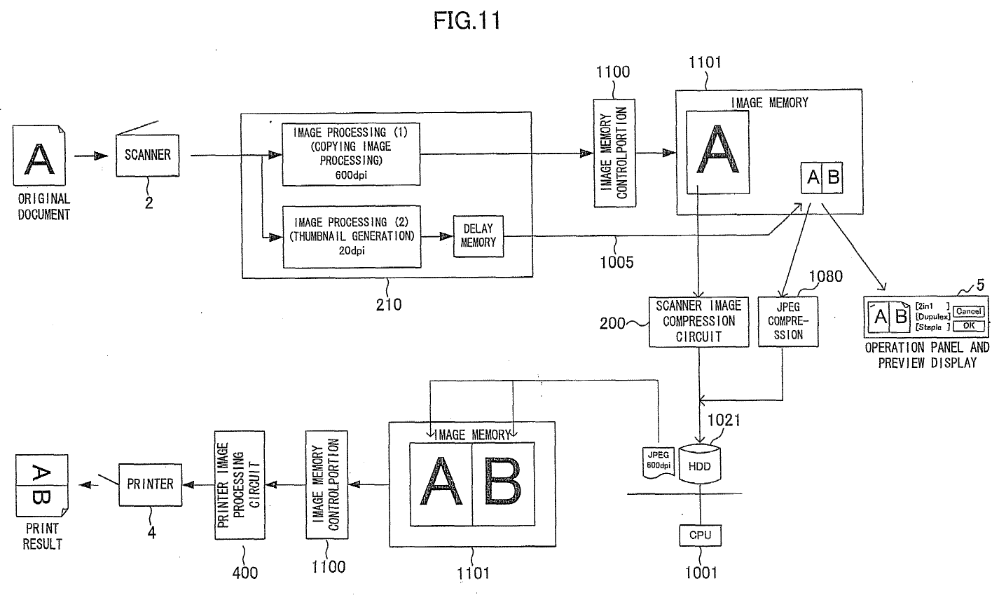

FIG. 11 is a view showing an example of a copying operation to prevent erroneous settings by the user by executing preview processing to display a print image to be outputted to the operation panel as soon as an original image is read in the “2-in-1 copy” in which two original documents are reduced and allocated to the same page.

Different from the fifth embodiment, in this embodiment, the image memory control portion 1100 transfers the scanned image as the processing result of the image processing (1) alone to the image memory 1101 two dimensionally.

The transfer of the scanned image to the image memory and the image processing (2) are executed simultaneously and the processing results are accumulated on the delay memory.

An image at 600 dpi as a scanned image for copying is cut out at the time of reading of the image memory, and converted to JPEG coding in the scanner image compression circuit 200 to be accumulated on the HDD 1021.

The host CPU is able to read out the reduced images on the delay memory generated by the image processing (2) so as to be transferred to the display memory of the operation panel (operation display portion 5) as preview images.

Also, the thumbnail images on the delay memory generated by the image processing (2) can be transferred to the JPEG compression 1080 by the host CPU and converted to JPEG coding so as to be accumulated on the HDD 1021.

As with the fifth embodiment, because the reading of original documents and the generation of the preview images can be executed simultaneously, it is possible to confirm an output image at an early stage without actually making print on a sheet of paper, which can in turn suppress the generation of an erroneous copy.

### Eighth Embodiment

An eighth embodiment of the invention will now be described. This embodiment is a modification of the first embodiment described above, and the basic apparatus configuration is the same as that of the first embodiment.

Hereinafter, an example of a copying operation that enables an image confirmation by a preview image by the image processing apparatus of this embodiment will be described.

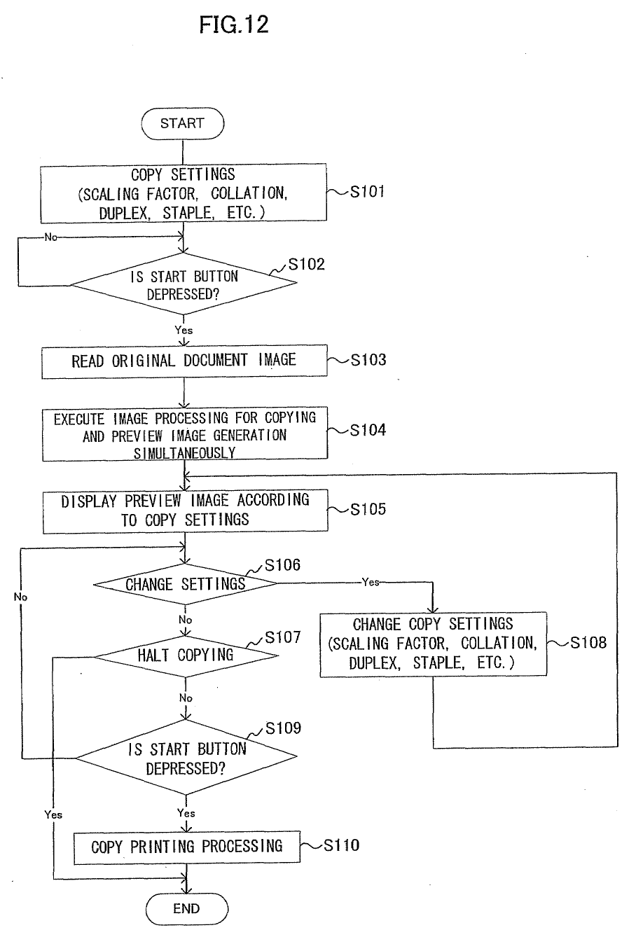

FIG. 12 is a flowchart used to describe the flow of the copying operation in the image processing apparatus of this embodiment.

Initially, the user sets desired print settings, such as a scaling factor, collation, duplex copying, stapling, hole punching, and so forth before the reading of an original document to be copied starts (S101). In a case where a number of print settings are combined complicatedly in this manner, it is difficult for the user to have an image in his head whether a final output is executed appropriately due to the posture of the original document and the duplex collation of the original document.

When the user depresses the start button (S102, Yes), the reading of the original document starts (S103).

The scanner image processing circuit 210 executes the image processing for copying and the preview image generation processing simultaneously on the image data of the original document scanned in the manner as described above (S104).

The preview image generated by the scanner image processing circuit 210 is generated using the actually read image in faithful accordance with the copying settings set by the user to be finally the preview image equal to the print image, and displayed on the operation display portion 5 (S105).

Although the input of an image is continued, the preview image is stopped at a stage when the combinations necessary to confirm the settings are displayed, and the apparatus is in a state where it waits for an instruction to start an output with the content of the preview, change the settings, or cancel the printing (S106 through S108).

When the user depresses the start button (S109, Yes), the print-output is started with the content of the preview (S110).

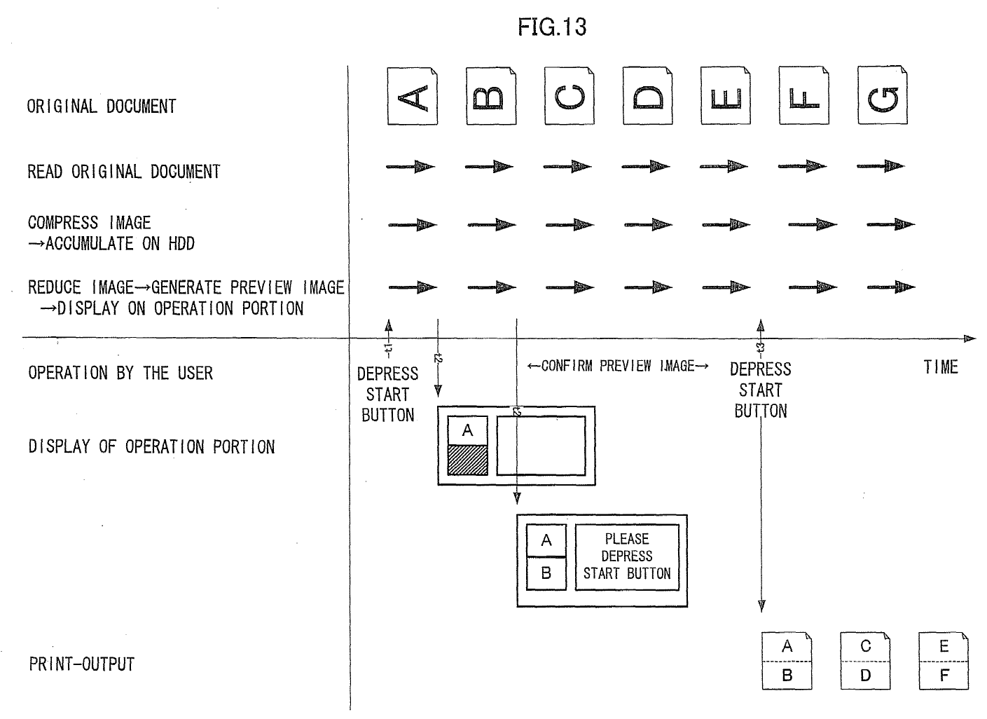

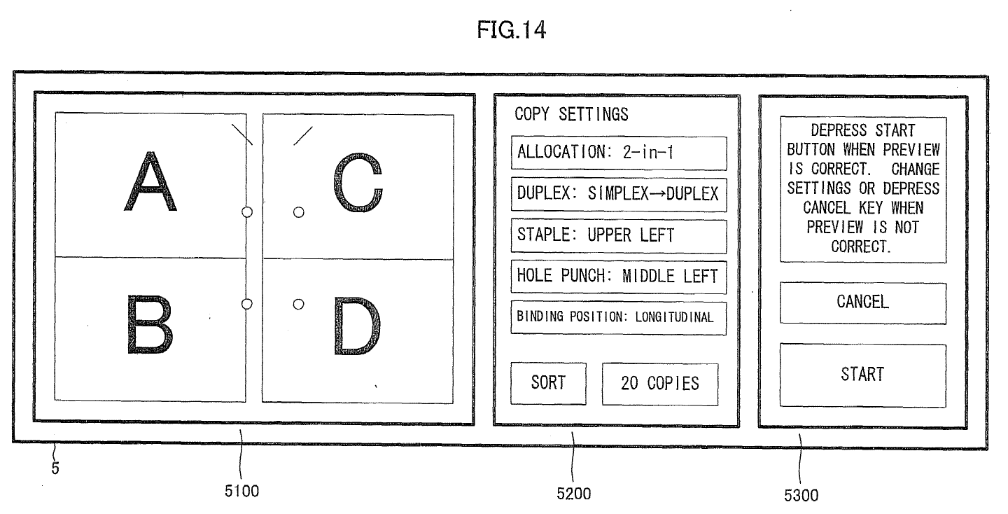

FIG. 13 is a view showing an example of an operation sequence specifying the timing of the reading of an original document, an operation by the user, a display on the operation portion, and a print-output. FIG. 14 is view showing an example of a screen display of the operation display portion 5.

The operation display portion 5 displays thereon a preview image 5100 generated using the actual read image in faithfully accordance with the copying settings (print settings) set by the user, copying settings 5200, and an operation instruction 5300.

The reduced image generation processing in this embodiment can be achieved by using any one of the generation methods of the first through fourth embodiments described above.

### Ninth Embodiment

A ninth embodiment of the invention will now be described. This embodiment is a modification of the first embodiment described above, and the basic apparatus configuration is the same as that of the first embodiment.

Hereinafter, an example of a copying operation that enables an image confirmation by a preview image of the image processing apparatus of this embodiment will be described.

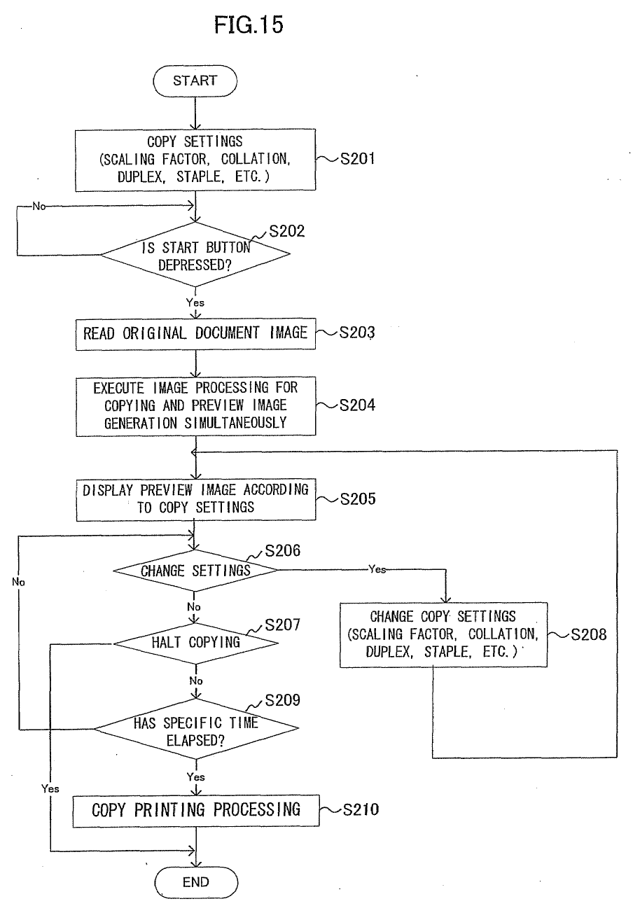

FIG. 15 is a flowchart used to describe the flow of the copying operation in the image processing apparatus of this embodiment.

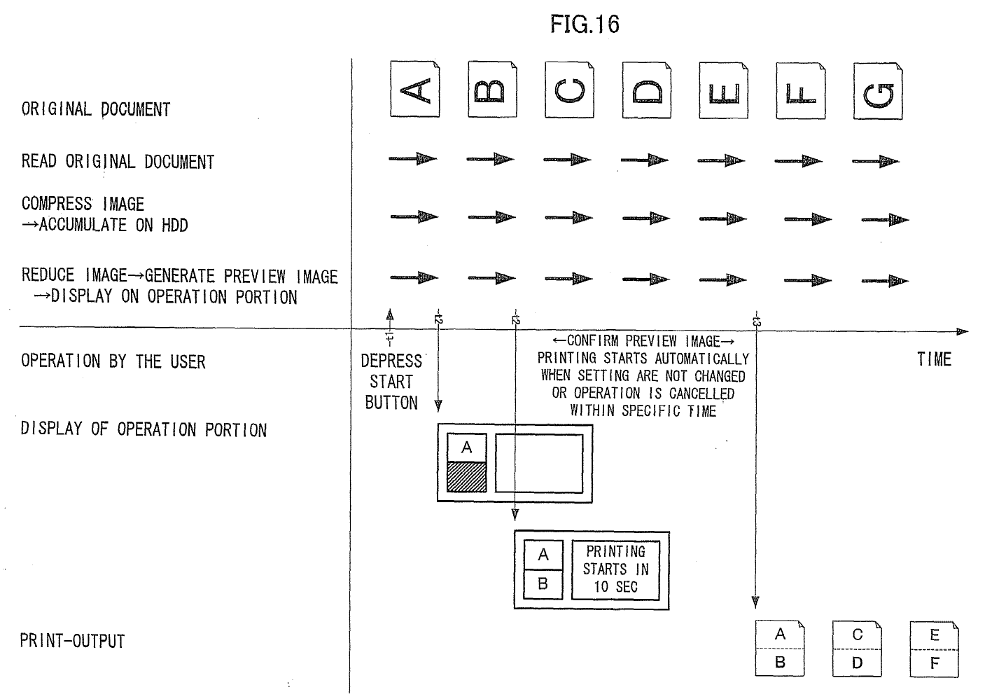

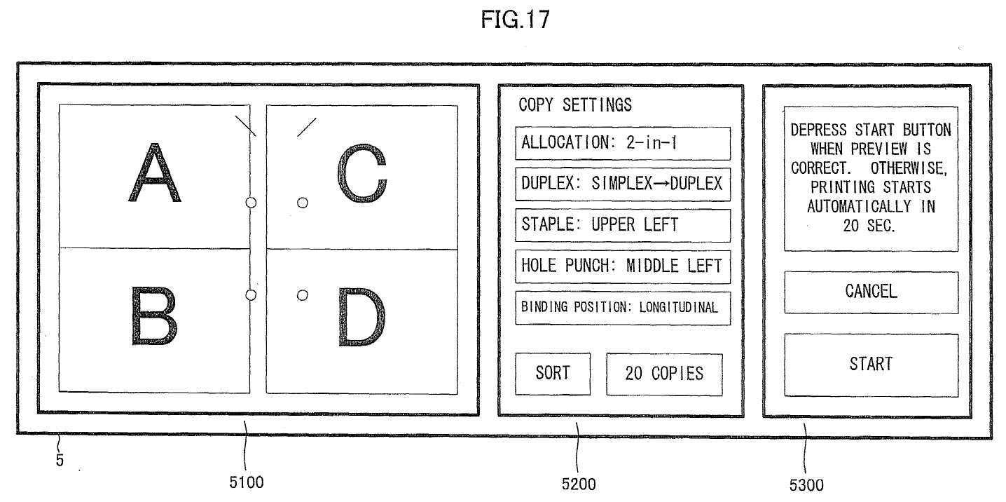

FIG. 16 is a view showing an example of an operation sequence specifying the timing of the reading of an original document, an operation by the user, a display on the operation portion, and a print-output. FIG. 17 is view showing an example of a screen display of the operation display portion 5.

The operation display portion 5 displays thereon a preview image 5100 generated using the actual read image in faithfully accordance with the copying settings set by the user, copying settings 5200, and an operation instruction 5300.

A difference between this embodiment and the eighth embodiment is that in a case where no instruction is given from the user, a printing operation starts when a specific time has elapsed since the preview display of the scanned image was started on the assumption that the setting content is correct.

As with the eighth embodiment, it is possible to change the setting or cancel the copying operation within the specific time. Also, it is possible to start a printing operation within the specific time.

The reduced image generation processing by the image processing apparatus in this embodiment can be achieved by using any one of the generation methods of the first through fourth embodiments described above.

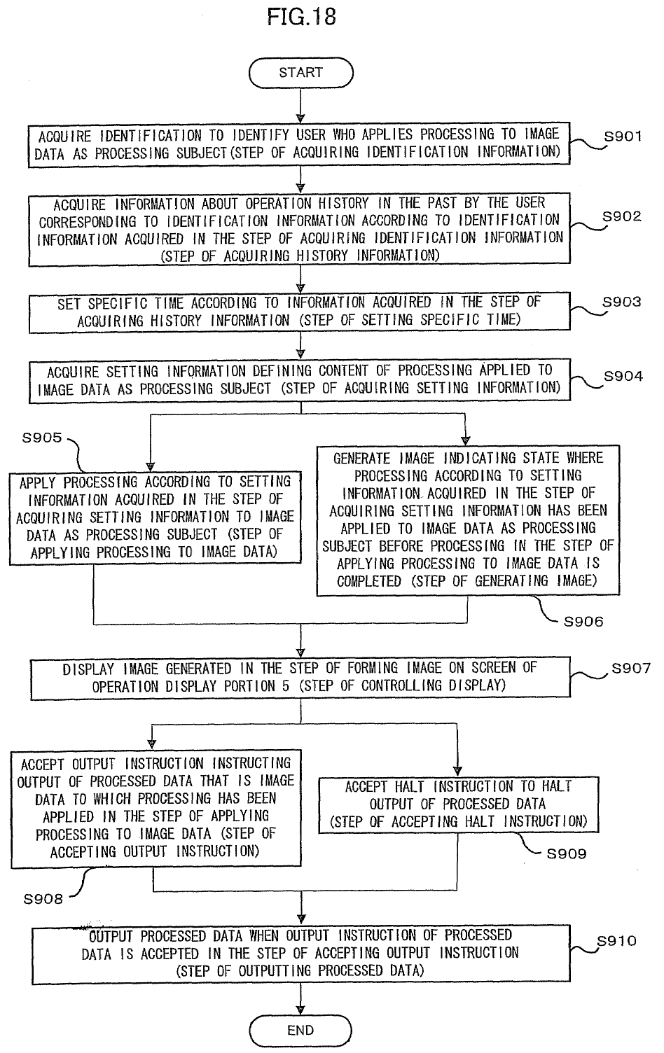

FIG. 18 is a flowchart used to roughly describe the flow of the processing (image processing method) in the image processing apparatus according to the embodiment of the invention.

The identification information acquisition portion 101 acquires the identification information to identify a user who applies the processing to the image data as the processing subject (the step of acquiring the identification information) (S901).

The history information acquisition portion 102 acquires the information about the operation history in the past by the user corresponding to the identification information according to the identification information acquired in the step of acquiring the identification information (the step of acquiring the history information) (S902).

The specific time setting portion 103 sets the specific time according to the information acquired in the step of acquiring the history information (the step of setting the specific time) (S903).

The setting information acquisition portion 104 acquires the setting information that defines the content of the processing applied to the image data as the processing subject (the step of acquiring the setting information) (S904).

The image processing portion 105 applies the processing according to the setting information acquired in the step of acquiring the setting information to the image data as the processing subject (the step of applying the processing to the image data) (S905).

The image forming portion 106 generates an image indicating the state where the processing according to the setting information acquired in the step of acquiring the setting information has been applied to the image data as the processing subject before the processing in the step of applying the processing to the image data is completed (the step of forming the image) (S906).

The display control portion 107 controls the operation display portion 5 to display the image generated in the step of forming the image on the screen thereof (the step of controlling the display) (S907).

The output instruction acceptance portion 108 accepts an output instruction instructing an output of processed data that is the image data to which the processing has been applied in the step of applying the processing to the image data (the step of accepting the output instruction) (S908). In the step of accepting the output instruction, it is determined that an output instruction instructing an output of the processed data is accepted in a case where a specific time has elapsed since the display of the image in the step of controlling the display was started. The specific time referred to herein can be set according to the content of the processing defined by the setting information acquired in the step of acquiring the setting information.

In the step of accepting the output instruction, for example, it is determined that an output instruction instructing an output of the processed data is accepted in a case where the output instruction of the processed data is accepted at the operation display portion 5 (the step of inputting the operation).

The halt instruction acceptance portion 110 accepts a halt instruction to halt an output of the processed data (the step of accepting the halt instruction) (S909).

The processed data output portion 111 outputs the processed data in a case where an output instruction of the processed data is accepted in the step of accepting the output instruction (the step of outputting the processed data) (S910). In the step of outputting the processed data, an output of the processed data is halted in a case where a halt instruction is accepted in the step of accepting the halt instruction since the image display is started until the specific time elapses in the step of controlling the display. To be more concrete, “an output of the processed data” corresponds, for example, to at least any one of “saving processing in the specific memory region”, “facsimile transmission processing”, “printing processing”, and “e-mail transmission processing”.

The respective steps in the processing by the image processing apparatus described above can be achieved by running the image processing program stored in the memory 802 on the CPU 1001.

By configuring as has been described, in a copying operation of a digital copying machine, a reduced image for a preview image to confirm the final print image using the operation display portion 5 is executed simultaneously with the normal copying image processing, and by executing a preview display according to the copying print settings, such as the duplex collation, the N-in-1, the stapling position, and the hole punching position, simultaneously with the reading of the image, the user is allowed to confirm the content of the print settings instantaneously, which can in turn forestall erroneous copying.

The embodiments have described a case where the capabilities to implement the invention are previously recorded in the apparatus. However, the invention is not limited to this configuration, and the same capabilities can be downloaded to the apparatus from the network, or the same capabilities recorded in a recording medium may be installed in the apparatus. The recording medium can be a recording medium of any format, such as a CD-ROM, as long as it is capable of storing the programs and readable by the apparatus. The capabilities obtained by pre-installment or downloading as described above may be those achieved in cooperation with the OS (Operating System) in the apparatus or the like.

While various embodiments of the invention have been described in detail, it is obvious that various modifications and improvements occur to anyone skilled in the art without deviating the sprit and the scope of the invention.

According to the invention as described above in detail, it is possible to provide a technique that can make a contribution to the control of execution of the processing according to an erroneous setting content in the image processing apparatus that applies processing according to the setting content to the image data.

What is claimed is:

1. An image processing apparatus, comprising:
a setting information acquisition unit configured to acquire setting information that defines a content of processing applied to image data as a processing subject;
an image processing unit configured to apply the processing according to the setting information acquired by the setting information acquisition unit to the image data as the processing subject;
an image generation unit configured to generate an image indicating a state where the processing according to the setting information acquired by the setting information acquisition unit has been applied to the image data as the processing subject before the processing in the image processing unit is completed;
a display control unit configured to display the image generated in the image generation unit;
an output instruction acceptance unit configured to accept an output instruction instructing an output of processed data that is the image data to which the processing has been applied in the image processing unit; and
a processed data output unit configured to output the processed data in a case where the output instruction of the processed data is accepted at the output instruction acceptance unit.

2. The image processing apparatus according to claim 1, wherein:
the output instruction acceptance unit determines that the output instruction instructing the output of the processed data is accepted in a case where a specific time has elapsed since an image display by the display control unit was started.

3. The image processing apparatus according to claim 2, further comprising:
a halt instruction acceptance unit configured to accept a halt instruction to halt an output of the processed data,
wherein the processed data output unit halts the output of the processed data in a case where the halt instruction is accepted at the halt instruction acceptance unit since an image display by the display control unit is started until a specific time elapses.

4. The image processing apparatus according to claim 2, wherein:
the specific time is set according to a content of the processing defined by the setting information acquired by the setting information acquisition unit.

5. The image processing apparatus according to claim 2, further comprising:
an identification information acquisition unit configured to acquire identification information that identifies a user who applies processing to the image data as the processing subject;
a history information acquisition unit configured to acquire information about an operation history in past times by the user corresponding to the identification information according to the identification information acquired by the identification information acquisition unit; and
a specific time setting unit configured to set the specific time according to the information acquired by the history information acquisition unit.

6. The image processing apparatus according to claim 1, further comprising:
an operation input unit configured to accept an operation input from a user,
wherein the output instruction acceptance unit determines that the output instruction instructing the output of the processed data is accepted in a case where the output instruction of the processed data is accepted at the operation input unit.

7. The image processing apparatus according to claim 1, wherein:
the output of the processed data is at least one of saving processing in a specific memory region, facsimile transmission processing, printing processing, and e-mail transmission processing.

8. An image processing apparatus, comprising:
setting information acquisition means for acquiring setting information that defines a content of processing applied to image data as a processing subject;
image processing means for applying the processing according to the setting information acquired by the setting information acquisition means to the image data as the processing subject;
image generation means for generating an image indicating a state where the processing according to the setting information acquired by the setting information acquisition means has been applied to the image data as the processing subject before the processing in the image processing means is completed;
display control means for displaying the image generated in the image generation means;
output instruction acceptance means for accepting an output instruction instructing an output of processed data that is the image data to which the processing has been applied in the image processing means; and
processed data output means for outputting the processed data in a case where the output instruction of the processed data is accepted at the output instruction acceptance means.

9. The image processing apparatus according to claim 8, wherein:
the output instruction acceptance means determines that the output instruction instructing the output of the processed data is accepted in a case where a specific time has elapsed since an image display by the display control means was started.

10. The image processing apparatus according to claim 9, further comprising:
halt instruction acceptance means for accepting a halt instruction to halt an output of the processed data,
wherein the processed data output means halts the output of the processed data in a case where the halt instruction is accepted at the halt instruction acceptance means since an image display by the display control means is started until a specific time elapses.

11. The image processing apparatus according to claim 9, wherein:
the specific time is set according to a content of the processing defined by the setting information acquired by the setting information acquisition means.

12. The image processing apparatus according to claim 9, further comprising:
identification information acquisition means for acquiring identification information that identifies a user who applies processing to the image data as the processing subject;
history information acquisition means for acquiring information about an operation history in past times by the user corresponding to the identification information according to the identification information acquired by the identification information acquisition means; and
specific time setting means for setting the specific time according to the information acquired by the history information acquisition means.

13. The image processing apparatus according to claim 8, further comprising:
operation input means for accepting an operation input from a user,
wherein the output instruction acceptance means determines that the output instruction instructing the output of the processed data is accepted in a case where the output instruction of the processed data is accepted at the operation input means.

14. An image processing method, comprising the steps of:
acquiring setting information that defines a content of processing applied to image data as a processing subject;
applying the processing according to the setting information acquired in the step of acquiring the setting information to the image data as the processing subject;
generating an image indicating a state where the processing according to the setting information acquired in the step of acquiring the setting information has been applied to the image data as the processing subject before the processing in the step of applying the processing to the image data is completed;
displaying the image generated in the step of generating the image;
accepting an output instruction instructing an output of processed data that is the image data to which the processing has been applied in the step of applying the processing to the image data; and
outputting the processed data in a case where the output instruction of the processed data is accepted in the step of accepting the output instruction.

15. The image processing method according to claim 14, wherein:
in the step of accepting the output instruction, it is determined that the output instruction instructing the output of the processed data is accepted in a case where a specific time has elapsed since an image display in the step of displaying the image was started.

16. The image processing method according to claim 15, further comprising the step of:
accepting a halt instruction to halt an output of the processed data,
wherein, in the step of haling the output of the processed data, the output of the processed data is halted in a case where the halt instruction is accepted in the step of accepting the halt instruction since an image display in the step of displaying the image is started until a specific time elapses.

17. The image processing method according to claim 15, wherein:
the specific time is set according to a content of the processing defined by the setting information acquired in the step of acquiring the setting information.

18. The image processing method according to claim 15, further comprising the steps of:
acquiring identification information that identifies a user who applies processing to the image data as the processing subject;
acquiring information about an operation history in past times by the user corresponding to the identification information according to the identification information acquired in the step of acquiring the identification information; and
setting the specific time according to the information acquired in the step of acquiring the history information.

19. The image processing method according to claim 14, further comprising the step of:
accepting an operation input from a user,
wherein, in the step of accepting the output instruction, it is determined that the output instruction instructing the output of the processed data is accepted in a case where the output instruction of the processed data is accepted in the step of inputting the operation.

20. The image processing method according to claim 14, wherein:
the output of the processed data is at least one of saving processing in a specific memory region, facsimile transmission processing, printing processing, and e-mail transmission processing.
